(19) United States
(12) Patent Application Publication
(10) Pub. No.: US 2022/0131249 A1
(43) Pub. Date: Apr. 28, 2022

(54) FILTER

(71) Applicant: FUJIKURA LTD., Tokyo (JP)

(72) Inventor: Yusuke Uemichi, Sakura-shi (JP)

(73) Assignee: FUJIKURA LTD., Tokyo (JP)

(21) Appl. No.: 17/428,132

(22) PCT Filed: Mar. 6, 2020
(86) PCT No.: PCT/JP2020/009550

§ 371 Date: Aug. 3, 2021

(30) Foreign Application Priority Data
Mar. 14, 2019 (JP) 2019-047551

(51) Int. Cl. H01P 1/208; H01P 3/12; H01P 7/06

(52) U.S. Cl. CPC H01P 1/208; H01P 7/06; H01P 3/12

(57) ABSTRACT

Provided is a filter capable of compensating property change caused due to temperature change. A filter (1) includes a post-wall waveguide serving as electromagnetically coupled resonators (201-205) and cavities (301a-305a) electromagnetically coupled to the resonators (201-205) via coupling windows (AP₁₀₁ₐ-AP₁₀₅ₐ) in a second conductor layer (6a) of the post-wall waveguide. A substrate (5) of the post-wall waveguide includes a first dielectric layer constituted by a first dielectric material, and a second dielectric layer (9a) constituted by a second dielectric material is provided inside the cavities (301a-305a). In the filter (1), a dielectric constant of the first dielectric material increases and a dielectric constant of the second dielectric material decreases due to the same range of temperature rise, or the dielectric constant of the first dielectric material decreases and the dielectric constant of the second dielectric material increases due to the same range of temperature rise.

### TECHNICAL FIELD

The present invention relates to a filter using a post-wall waveguide. In particular, the present invention relates to a filter having a temperature compensation function.

### BACKGROUND ART

It is known that a plurality resonators that are electromagnetically coupled to each other function as a bandpass filter (hereinafter also referred to as “BPF”) that selectively allows electromagnetic waves to pass in a particular frequency band (hereinafter also referred to as “passband”).

Non-patent Literature 1 discloses a bandpass filter using a metallic waveguide tube functioning as a plurality of resonators. Non-patent Literature 1 also discloses a technique for adjusting a center frequency in this bandpass filter.

Non-patent Literature 2 discloses a bandpass filter using a post-wall waveguide functioning as a plurality of resonators. Here, the term “post-wall waveguide” refers to a waveguide realized by a substrate which includes broad walls that are provided on both main surfaces and includes a post wall (i.e., a set of conductor posts with which a short circuit is achieved between the broad wall provided on one main surface and the broad wall provided on the other main surface) that is provided inside the substrate.

### CITATION LIST

### Non-Patent Literature

[Non-Patent Literature 1]
Kazuaki YOSHIDA, “Technology and Applications of Microwave Filters,” JRC Review, No. 64, pp. 12-16, 2013.

[Non-Patent Literature 2]
Yusuke Uemichi, et. al, Compact and Low-Loss Bandpass Filter Realized in Silica-Based Post-Wall Waveguide for 60-GHz applications, IEEE MTT-S IMS, May 2015.

### SUMMARY OF INVENTION

### Technical Problem

A BPF utilizing a post-wall waveguide is more compact, has less transmission loss, and is easier to integrate as a part of radio frequency integrated circuit (RFIC), as compared to a BPF utilizing a waveguide tube. In addition, the BPF utilizing the post-wall waveguide can be manufactured with a manufacturing method of a printed circuit board, and therefore a manufacturing cost can be kept lower, as compared to the BPF utilizing the waveguide tube.

Meanwhile, the BPF utilizing the post-wall waveguide has a problem that a center frequency of a passband is easily shifted according to an environmental temperature. This is because, as the environmental temperature changes, the dielectric constant of a dielectric material that constitutes the substrate changes and, as a result, the center frequency of the passband is shifted. In particular, such a problem is conspicuous in an environment in which the temperature largely changes.

One aspect of the present invention is attained in view of the above problem, and its object is to provide a filter which includes a post-wall waveguide and in which a center frequency of a passband is shifted less in accordance with change in temperature, as compared to a conventional filter.

### Solution to Problem

In order to attain the object, a filter in accordance with an aspect of the present invention includes: a post-wall waveguide which includes a substrate that is provided with a first conductor layer on one main surface, a second conductor layer on the other main surface, and post walls disposed inside the substrate, the post-wall waveguide functioning as a plurality of resonators which are electromagnetically coupled to each other; and cavities which are disposed on the post-wall waveguide, the cavities being electromagnetically coupled to the respective plurality of resonators via coupling windows that are provided in the second conductor layer, the substrate including a first dielectric layer which is constituted by a first dielectric material, each of the cavities including therein a second dielectric layer which is constituted by a second dielectric material, a dielectric constant of the first dielectric material increasing in accordance with temperature rise and a dielectric constant of the second dielectric material decreasing in accordance with temperature rise which is in the same range as said temperature rise, or the dielectric constant of the first dielectric material decreasing in accordance with temperature rise and the dielectric constant of the second dielectric material increasing in accordance with temperature rise which is in the same range as said temperature rise.

### Advantageous Effects of Invention

According to an aspect of the present invention, the plurality of dielectric materials are combined so as to cancel or reduce temperature dependences thereof, and this makes it possible to bring about an effect of reducing shift of a center frequency of a passband caused in accordance with change in temperature.

### BRIEF DESCRIPTION OF DRAWINGS

FIG. 1 is an exploded perspective view illustrating a BPF 1 in accordance with Embodiment 1.

FIG. 2 is an exploded perspective view illustrating a BPF 2 in accordance with Embodiment 2.

FIG. 3 is a plan view corresponding to the exploded perspective views of (c) of FIG. 1 and (c) of FIG. 2.

(a) and (b) of FIG. 4 are plan views corresponding to the exploded perspective views of (a) of FIG. 1 and (a) of FIG. 2, respectively.

(a) and (b) of FIG. 5 are plan views corresponding to the exploded perspective views of (b) of FIG. 1 and (b) of FIG. 2, respectively.

FIG. 6 is a cross-sectional view of the BPF 1 in accordance with Embodiment 1 taken along the line B-B′ in FIG. 3.

FIG. 7 is a cross-sectional view of the BPF 2 in accordance with Embodiment 2 taken along the line B-B′ in FIG. 3.

(a) and (b) of FIG. 8 are a plan view and a cross-sectional view, respectively, illustrating a converter which can be provided at an end of a waveguide of the BPF 1 or BPF 2.

FIG. 9 is a graph showing a simulation result of a transmission characteristic of a BPF in which a substrate 5 includes a first cavity that is constituted by single quartz.

### DESCRIPTION OF EMBODIMENTS

[Configuration of Bandpass Filter]

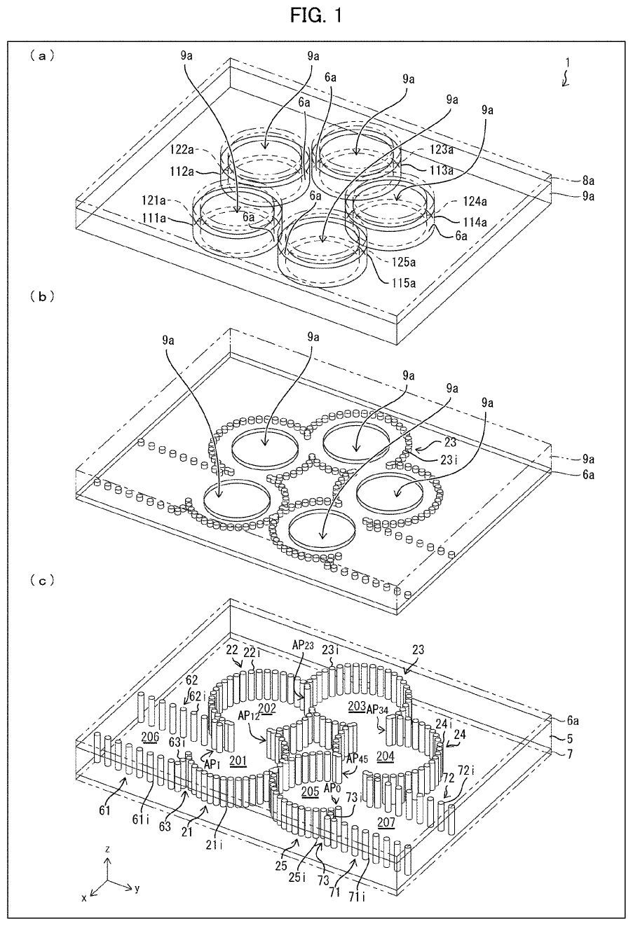

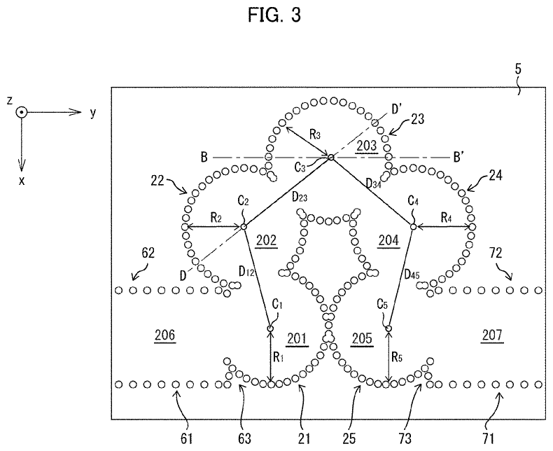

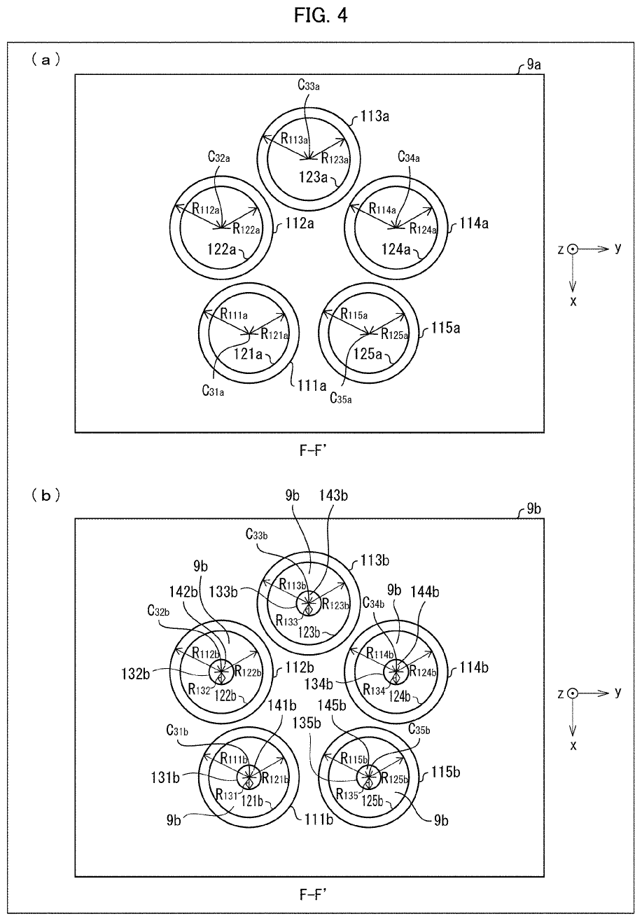

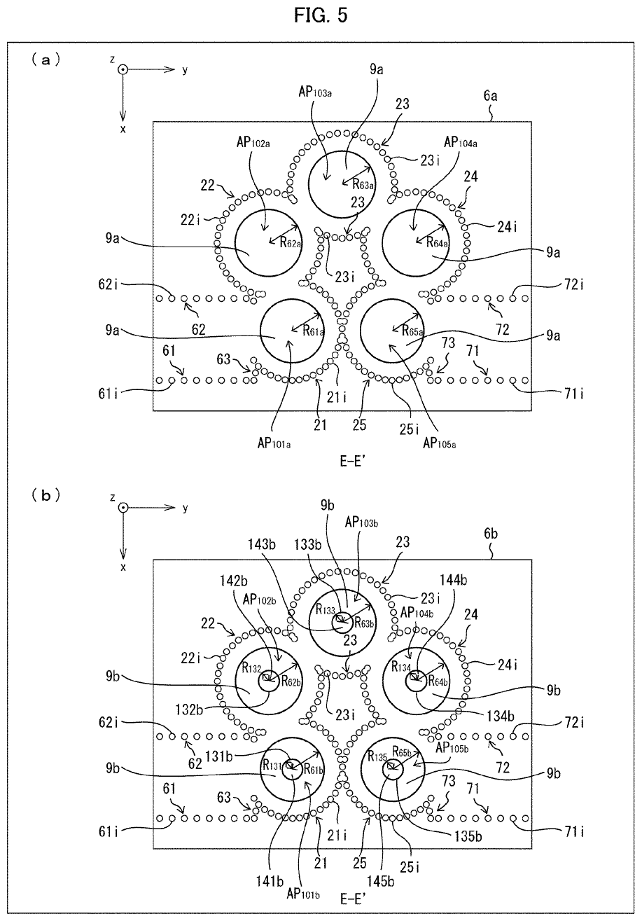

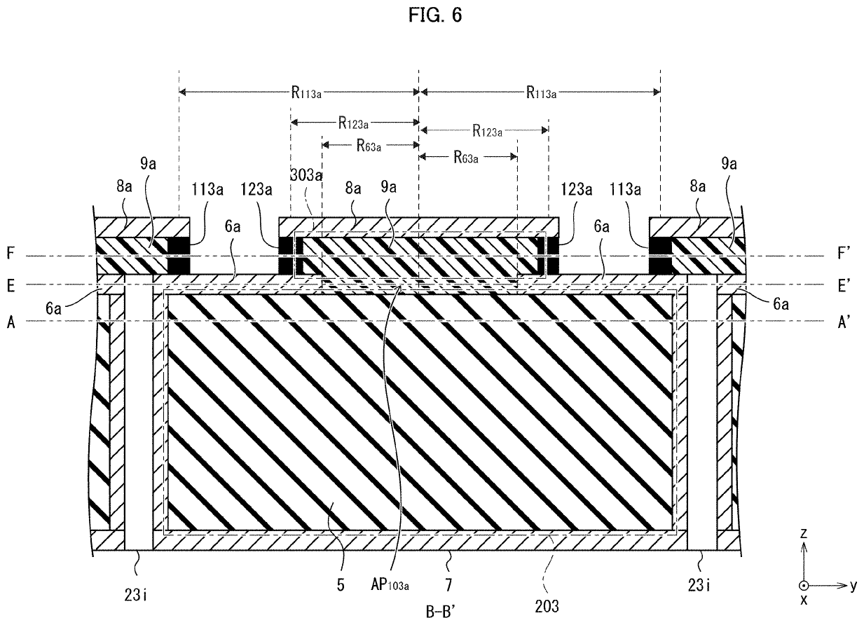

A bandpass filter 1 (hereinafter, simply referred to also as “BPF 1”) in accordance with Embodiment 1 of the present invention will be described with reference to FIG. 1, FIG. 3, (a) of FIG. 4, (a) of FIG. 5, and FIG. 6. FIG. 1 is an exploded perspective view illustrating the BPF 1 in accordance with Embodiment 1. FIG. 3 is a plan view corresponding to the exploded perspective view of (c) of FIG. 1. (a) of FIG. 4 is a plan view corresponding to the exploded perspective view of (a) of FIG. 1. (a) of FIG. 5 is a plan view corresponding to the exploded perspective view of (b) of FIG. 1. FIG. 6 is a cross-sectional view of the BPF 1 taken along the line B-B′ in FIG. 3.

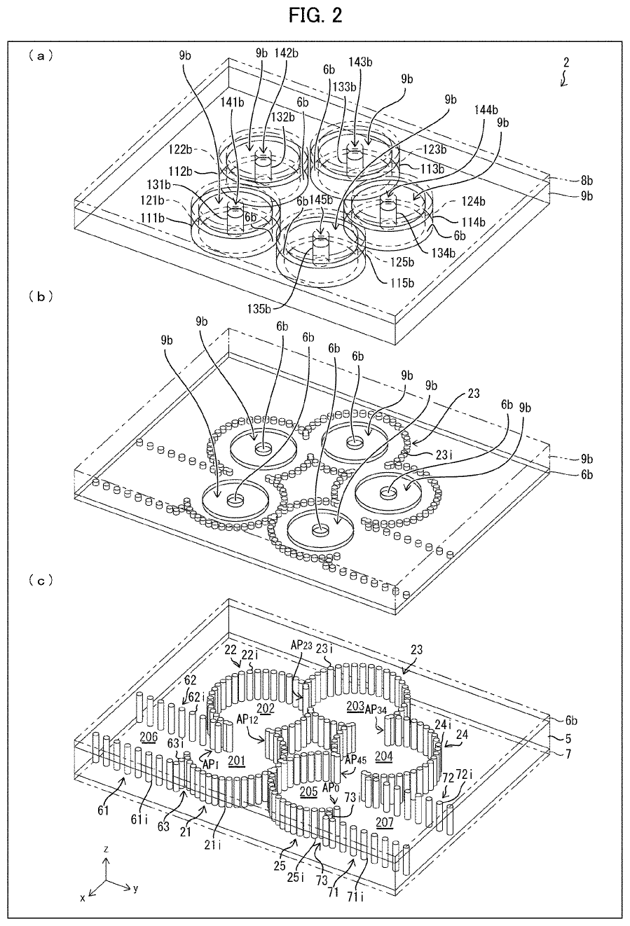

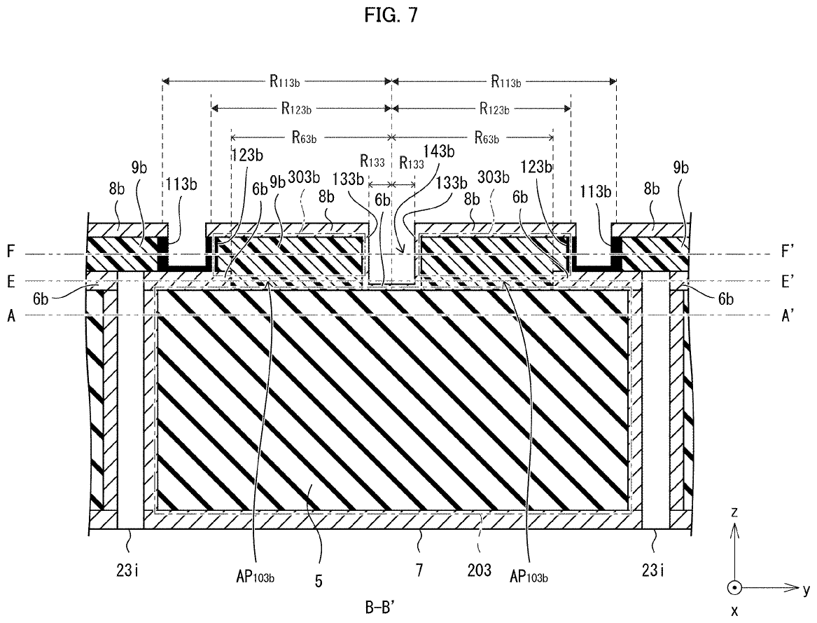

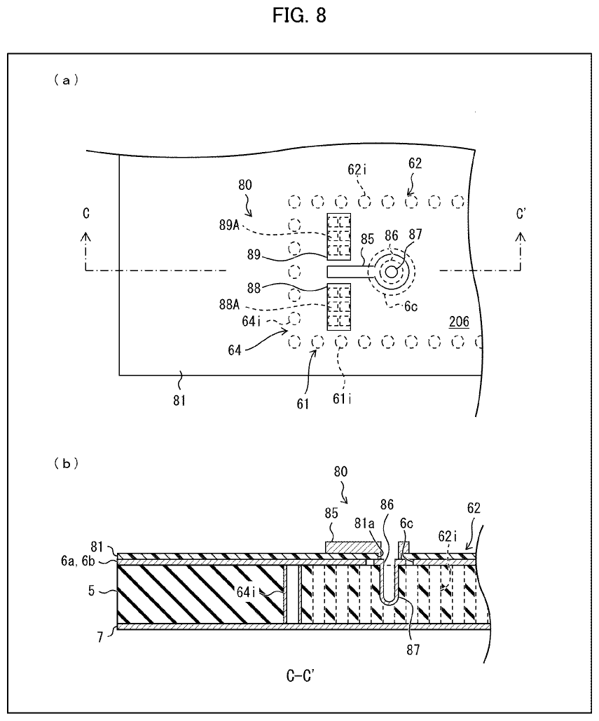

A bandpass filter 2 (hereinafter, simply referred to also as “BPF 2”) in accordance with Embodiment 2 of the present invention will be described with reference to FIG. 2, FIG. 3, (b) of FIG. 4, (b) of FIG. 5, and FIG. 7. FIG. 2 is an exploded perspective view illustrating the BPF 2 in accordance with Embodiment 2. FIG. 3 is a plan view corresponding to the exploded perspective view of (c) of FIG. 2. (b) of FIG. 4 is a plan view corresponding to the exploded perspective view of (a) of FIG. 2. (b) of FIG. 5 is a plan view corresponding to the exploded perspective view of (b) of FIG. 2. FIG. 7 is a cross-sectional view of the BPF 2 taken along the line B-B′ in FIG. 3.

First, a configuration and a converter which are common to the BPF 1 and the BPF 2 will be described, and then a configuration unique to the BPF 1 and a configuration unique to the BPF 2 will be described. In order to understand the present invention, each of the drawings showing the configuration of the BPF is a schematic view which gives priority to understandability, and a scale ratio, an orientation, and the like of each constituent element are not necessarily accurate.

<Configuration Common to Bandpass Filters>

As illustrated in (c) of FIG. 1 and (c) of FIG. 2, each of the BPF 1 and the BPF 2 includes a post-wall waveguide which is constituted by: a substrate 5 made of a dielectric material (corresponding to “first dielectric layer” in claims); a conductor layer 6a or 6b (corresponding to “second conductor layer” in claims) and a conductor layer 7 (corresponding to “first conductor layer” in claims) which serve as a pair of broad walls; and post walls 21 through 25, 61 through 63, and 71 through 73 which serve as a pair of narrow walls. Note that the conductor layers 6a and 6b respectively illustrated in (c) of FIG. 1 and (c) of FIG. 2 and the conductor layer 7 illustrated in (c) of FIG. 1 and (c) of FIG. 2 are depicted by virtual lines (i.e., two-dot chain lines). This is to make it easier to see the plurality of conductor posts provided inside the substrate 5.

In (b) of FIG. 1 and (b) of FIG. 2, the conductor layers 6a and 6b, which are indicated by the virtual lines in respective (c) of FIG. 1 and (c) of FIG. 2, are indicated by solid lines, and resin layers 9a and 9b (corresponding to “second dielectric layer” in claims) respectively disposed on the conductor layers 6a and 6b are indicated by virtual lines (i.e., two-dot chain lines). This is to make it easier to see various structures provided on the conductor layers 6a and 6b.

In (a) of FIG. 1 and (a) of FIG. 2, the resin layers 9a and 9b, which are indicated by the virtual lines in respective (b) of FIG. 1 and (b) of FIG. 2, are indicated by solid lines, and conductor layers 8a and 8b (corresponding to “third dielectric layer” in claims) respectively disposed on the resin layers 9a and 9b are indicated by virtual lines (i.e., two-dot chain lines). This is to make it easier to see various structures provided on the resin layers 9a and 9b.

<Configuration of Post-Wall Waveguide>

(Substrate)

The substrate 5 is a plate-like member constituted by a dielectric material. In the following description, two surfaces having the largest area among six surfaces constituting the substrate 5 are referred to as main surfaces of the substrate 5. In the present embodiment, quartz is employed as a dielectric material constituting the substrate 5. However, it is possible to employ another dielectric material (e.g., a resin such as a Teflon (registered trademark) based resin such as polytetrafluoroethylene or a liquid crystal polymer resin).

In a case where quartz glass is employed as the substrate 5, a thickness of the quartz glass can be set to 520 μm.

(Pair of Broad Walls)

The conductor layer 6a or 6b and the conductor layer 7 are a pair of conductor layers provided on the respective two main surfaces of the substrate 5. That is, the BPF 1 has a multilayered structure in which the substrate 5 is sandwiched by the conductor layers 6a and 7, and the BPF 2 has a multilayered structure in which the substrate 5 is sandwiched by the conductor layers 6b and 7. In the present embodiment, copper is employed as a conductor constituting the conductor layers 6a, 6b, and 7. However, it is possible to employ another conductor (e.g., a metal such as aluminum). Thicknesses of the conductor layers 6a, 6b, and 7 are not limited, and it is possible to arbitrarily set the thicknesses. That is, an aspect of each of the conductor layers 6a, 6b, and 7 can be a thin film, a foil (film), or a plate.

The conductor layers 6a and 7 constitute a pair of the broad walls of the post-wall waveguide, and the conductor layers 6b and 7 constitute a pair of the broad walls of the post-wall waveguide.

(Post Wall)

The substrate 5 has a plurality of through-holes which are in a palisade arrangement. In regard to the plurality of through-holes, intervals between the through-holes are sufficiently shorter than a wavelength. The plurality of through-holes penetrate the substrate 5 from one main surface to the other main surface. A tube-shaped conductor film is disposed on an inner wall of each of the plurality of through-holes. As such, the tube-shaped conductor films function as conductor posts provided in the dielectric substrate 5. Further, the tube-shaped conductor films achieve a short circuit between the conductor layer 6a or 6b and the conductor layer 7 which are provided on both main surfaces of the substrate 5. Such conductor posts can be provided using a technology of post-wall waveguide (technology of printed circuit board). The inner walls of the through-holes do not need to be constituted by the tube-shaped conductor films, and the through-holes can be filled with conductors.

A diameter of the conductor posts can be 100 μm, and intervals between adjacent conductor posts can be 200 μm.

In the present embodiment, copper is employed as a metal constituting the narrow wall. The metal is not limited to copper, and can be aluminum or can be an alloy constituted by a plurality of metal elements.

<Function of Post-Wall Waveguide>

The post walls 21 through 25, 61 through 63, and 71 through 73 provided inside the substrate 5 are arranged so that the post-wall waveguide functions as a plurality of (five in the present embodiment) resonators 201 through 205 and as waveguides 206 and 207 which are respectively provided in front and behind the resonators 201 through 205.

(Configuration of Resonators 201 Through 205)

The resonator 201 is formed by: two broad walls which face each other; and a narrow wall which resides between the two broad walls. The two broad walls are constituted by a metal conductor layer 6a or 6b and a metal conductor layer 7, respectively. The resonator 201 is in the shape of a circle on an x-y plane, except in portions where openings AP₁ and AP₁₂ are located. In another preferred embodiment, the shape can be a regular polygonal shape with six or more vertices, instead of the circular shape. In the case where the shape is a regular polygonal shape, the circumscribed circle of the regular polygonal shape corresponds to the above circular shape. The openings AP₁ and AP₁₂ will be described later. The opening is called also an inductive iris or a connecting part.

The narrow walls of the resonators 201 through 205 are constituted by post walls 21 through 25, respectively. The post walls 21 through 25 are constituted by k pieces of conductor posts 21i through 25i (i is a notation generalizing an integer of not less than 1 and not more than k). The post walls 21 through 25 allow electrical communication between the two broad walls which are respectively constituted by the conductor layer 6a or 6b and the conductor layer 7, and each of the post walls 21 through 25 is combined with the two broad walls to form a cylindrical space that is electromagnetically closed except for the openings AP₁ and AP₁₂.

Each of the openings AP₁ and AP₁₂ corresponds to a chord which is of the circular resonator 201 on the x-y plane and is obtained by cutting off a part of the broad walls and a part of the narrow wall in a direction perpendicular to the x-y plane. The opening AP₁ allows electromagnetic coupling between the waveguide 206 (described later) and the resonator 201, and the opening AP₁₂ allows electromagnetic coupling between the resonator 201 and the resonator 202 (described later).

Each of the resonators 202 through 205 is configured similarly to the resonator 201. Specifically, each of the resonators 202 through 205 is constituted by: two broad walls which are respectively constituted by the conductor layer 6a or 6b and the conductor layer 7; and a narrow wall which is constituted by any of the post walls 22 through 25. The shape of the resonator 202 on the x-y plane is a circular shape except in portions where openings AP₁₂ and AP₂₃ are located, the shape of the resonator 203 on the x-y plane is a circular shape except in portions where openings AP₂₃ and AP₃₄ are located, the shape of the resonator 204 on the x-y plane is a circular shape except in portions where openings AP₃₄ and AP₄₅ are located, and the shape of the resonator 205 on the x-y plane is a circular shape except in portions where openings AP₄₅ and AP_{O} are located. The opening AP₂₃ allows electromagnetic coupling between the resonator 202 and the resonator 203, the opening AP₃₄ allows electromagnetic coupling between the resonator 203 and the resonator 204, the opening AP₄₅ allows electromagnetic coupling between the resonator 204 and the resonator 205, and the opening AP_{O} allows electromagnetic coupling between the resonator 205 and the waveguide 207 (described later).

As has been described, (c) of FIG. 1 and (c) of FIG. 2 show an aspect in which the five resonators 201 through 205 are electromagnetically coupled to each other.

(Center-to-Center Distance Between Resonators)

The center of a circle on the conductor layer 6a or 6b corresponding to the resonator 201 on the x-y plane is referred to as center C₁₁, and the center of a circle on the conductor layer 7 corresponding to the resonator 201 on the x-y plane is referred to as center C₁₂. A center C₁ of the resonator 201 resides at the midpoint between the center C₁₁ and the center C₁₂. A center C₂ of the resonator 202, a center C₃ of the resonator 203, a center C₄ of the resonator 204, and a center C₅ of the resonator 205 are defined in a similar manner to the center C₁ of the resonator 201 (see FIG. 3).

As illustrated in FIG. 3, the radius of the resonator 201 is referred to as R₁, the radius of the resonator 202 is referred to as R₂, the radius of the resonator 203 is referred to as R₃, the radius of the resonator 204 is referred to as R₄, and the radius of the resonator 205 is referred to as R₅. Furthermore, the distance (hereinafter referred to as center-to-center distance) between the center C₁ and the center C₂ is referred to as D₁₂, the center-to-center distance between the center C₂ and the center C₃ is referred to as D₂₃, the center-to-center distance between the center C₃ and the center C₄ is referred to as D₃₄, and the center-to-center distance between the center C₄ and the center C₅ is referred to as D₄₅.

In the above arrangement, the radius R₁, the radius R₂, and the center-to-center distance D₁₂ satisfy the condition D₁₂<R₁+R₂, the radius R₂, the radius R₃, and the center-to-center distance D₂₃ satisfy the condition D₂₃<R₂+R₃, the radius R₃, the radius R₄, the center-to-center distance D₃₄ satisfy the condition D₃₄<R₃+R₄, and the radius R₄, the radius R₅, and the center-to-center distance D₄₅ satisfy the condition D₄₅<R₄+R₅. Provided that such a condition is satisfied, two cylindrical resonators (for example, the resonator 201 and the resonator 202) can be connected to each other via an opening in the side walls of the resonators (for example, via the opening AP₁₂).

(Symmetry of Two Adjacent Resonators)

Of the plurality of resonators, a focus is placed on two adjacent resonators connected to each other. The following description is based on the resonator 202 and the resonator 203. The shape of a combination of the two resonators 202 and 203 on the x-y plane (equal to the shape of a combination of the circumscribed circles of the resonators 202 and 203) is symmetric with respect to the line D-D′ that connects the centers C₂ and C₃ of the two circumscribed circles together (see FIG. 3). This makes it possible to easily design a filter with desired characteristics.

Note that, in the present embodiment, not only two resonators connected to each other but also each of the BPF 1 and BPF 2 as a whole is symmetric with respect to a line. Specifically, the resonators 201 through 205 are arranged to be symmetric with respect to a line that is parallel to the x axis and that passes through the center C₃ of the resonator 203, and the waveguides 206 and 207 are arranged to be symmetric with respect to that line. Thus, each of the BPF 1 and BPF 2 makes it possible to more easily design a filter having desired characteristics.

(Arrangement of Resonators 201 and 205)

In the present embodiment, the resonator 201 and the resonator 205 are arranged so as to be adjacent to each other (see (c) of FIG. 1, (c) of FIG. 2, and FIG. 3). Therefore, the total length of the filter can be reduced as compared to the configuration disclosed in Non-patent Literature 1 in which a plurality of resonators are arranged in a straight line.

(Configuration of Waveguides 206 and 207)

The waveguide 206 is a rectangular waveguide which has a rectangular cross section and is constituted by the two broad walls, which are respectively constituted by the conductor layer 6a or 6b and the conductor layer 7, and the post walls 61 and 62 which constitute a pair of narrow walls. At an end of the waveguide 206 on the resonator 201 side, a short wall 63 is provided in which an opening having the same shape as the opening AP₁ of the resonator 201 is formed. The waveguide 206 and the resonator 201 are electromagnetically coupled to each other by connecting the waveguide 206 and the resonator 201 so that the opening coincides with the aperture AP₁ of the resonator 201.

As with the waveguide 206, the waveguide 207 is a rectangular waveguide which is constituted by the tow broad walls, which are respectively constituted by the conductor layer 6a or 6b and the conductor layer 7, and the post walls 71 and 72 which constitute a pair of narrow walls. The waveguide 207 and the resonator 205 are electromagnetically coupled to each other by connecting the waveguide 207 and the resonator 205 so that an opening provided in a short wall 73 of the waveguide 207 coincides with the aperture AP_{O} of the resonator 205.

In the present embodiment, the end of the waveguide 206 positioned on the negative y axis direction side and the end of the waveguide 207 positioned on the positive y axis direction side both function as input-output ports. In a case where the end of the waveguide 206 positioned on the negative y axis direction side serves as an input port, the end of the waveguide 207 positioned on the positive y axis direction side serves as an output port. In a case where the end of the waveguide 207 positioned on the positive y axis direction side serves as an input port, the end of the waveguide 206 positioned on the negative y axis direction side serves as an output port. It is possible to arbitrarily use either of the input-output ports as an input port. In the present embodiment, the end of the waveguide 206 positioned on the negative y axis direction side is used as the input port, and the end of the waveguide 207 positioned on the positive y axis direction side is used as the output port. That is, the resonator 201 is a resonator of the initial pole (first pole), and the resonator 205 is a resonator of the final pole (fifth pole).

<Converter>

Each of the BPF 1 and BPF 2 is coupled to other high-frequency device(s) at its preceding stage and/or following stage. Examples of the high-frequency device coupled to the BPF 1 or BPF 2 include an antenna circuit, a transmitter circuit, a receiver circuit, and a directional coupler.

In a case of a high-frequency device (e.g., a directional coupler) that is preferably coupled to the BPF 1 or 2 using a rectangular waveguide, one end of the rectangular waveguide of the high-frequency device can be coupled to an open end of the waveguide 206 or the waveguide 207 of the BPF 1 or 2.

Meanwhile, in a case of a high-frequency device (e.g., a transmitter circuit and a receiver circuit) that is preferably coupled to the BPF 1 or 2 using a microstrip line, a converter can be provided in an open end of the BPF 1 or 2 so that the high-frequency device is coupled to the BPF 1 or 2 via the converter.

The following description will discuss a converter 80 which is connectable to each of the BPF 1 and the BPF 2. (a) and (b) of FIG. 8 are a plan view and a cross-sectional view, respectively, illustrating the converter 80 which can be provided at the end of the waveguide 206 positioned on the negative y axis direction side.

In each of the BPF 1 and BPF 2, the waveguide 206 can have the converter 80 illustrated in FIG. 8 provided at the end positioned on the negative y axis direction side. In a preferred embodiment, the converter 80 at the end positioned on the negative y axis direction side of the waveguide 206 can be an input converter. Similarly, the waveguide 207 may have the converter 80 provided at the end positioned on the positive y axis direction side. In a preferred embodiment, the converter 80 at the end positioned on the positive y axis direction side of the waveguide 207 can be an output converter. The following description is based on the converter 80 provided at the end positioned on the negative y axis direction side of the waveguide 206 as an example.

In the case where the converter 80 is provided at the end positioned on the negative y axis direction side of the waveguide 206, a short wall 64 is formed at that end. The short wall 64 is a post wall constituted by p pieces of conductor posts 64i (i is a notation generalizing an integer of not less than 1 and not more than p) arranged in a palisade arrangement. The short wall 64 is a counterpart of the short wall 63, and closes the opposite end of the waveguide 206 from the resonator 201.

As illustrated in (a) and (b) of FIG. 8, the converter 80 includes a signal line 85, a pad 86, a blind via 87, and electrodes 88 and 89.

A dielectric layer 81 is a layer made of a dielectric material provided on a surface of the conductor layer 6a or 6b. The dielectric layer 81 has an opening 81a. The conductor layer 6a or 6b of the converter 80 has an opening 6c that overlaps the opening 81a. The opening 6c is formed such that the opening 6c includes the opening 81a within its range. The opening 6c functions as an anti-pad.

The signal line 85 is a long narrow conductor disposed on a surface of the dielectric layer 81. One end portion of the signal line 85 lies in a region that surrounds the opening 81a. The signal line 85 and the conductor layer 6a or 6b form a microstrip line.

The pad 86 is a circular conductor layer provided on the surface of the substrate 5 on which the conductor layer 6a or 6b is provided. The pad 86 is located within the opening 6c in the conductor layer 6a or 6b such that the pad 86 is insulated from the conductor layer 6a or 6b.

The substrate 5 has, on the surface thereof, a non-through-hole extending inward from the surface on which the conductor layer 6a or 6b is provided. The blind via 87 is constituted by a tube-shaped conductor film disposed on the inner wall of the non-through-hole. The blind via 87 is connected to the one end portion of the signal line 85 via the pad 86 so that the blind via 87 and the signal line 85 are in electrical communication with each other. Specifically, the blind via 87 is connected to the one end portion of the signal line 85 and is formed in the substrate 5 through the openings 81a and 6c. The blind via 87 is referred to also as “conductor pin”. The blind via 87 does not need to be constituted by a tube-shaped conductor film disposed on the inner wall of the non-through-hole, and can be constituted by a conductor with which the non-through-hole is filled.

The electrodes 88 and 89 are disposed on the surface of the dielectric layer 81. The electrodes 88 and 89 are each located near the other end portion of the signal line 85 such that the other end portion of the signal line 85 lies between the electrodes 88 and 89.

The dielectric layer 81 has a plurality of through-holes in a region that overlaps the electrode 88. In the plurality of through-holes, tube-shaped conductor films serving as vias 88A are respectively disposed. The inner walls of the through-holes do not need to be constituted by the tube-shaped conductor films, and the through-holes can be filled with conductors. The vias 88A achieve a short circuit between the electrode 88 and the conductor layer 6a or 6b. Vias 89A, which are configured similarly to the vias 88A, achieve a short circuit between the electrode 89 and the conductor layer 6a or 6b. The thus-configured electrode 88 and electrode 89 each function as a ground, and therefore the electrode 88, the electrode 89, and the signal line 85 achieve a ground-signal-ground interface.

The thus-configured converter 80 carries out a conversion between a mode that propagates through the microstrip line and a mode that propagates through the waveguide 206. Therefore, the converter 80 is capable of easily coupling the microstrip line to each of the input and output ports. Furthermore, an RFIC can be easily connected to the interface constituted by the signal line 85 and the electrodes 88 and 89, with use of a bump or the like.

This configuration example has been described based on the assumption that the converter 80 is provided at the end of the waveguide 206 or the end of the waveguide 207. That is, the configuration example has been described based on the assumption that the converter 80 is coupled to the resonator 201 or the resonator 205 via the waveguide 206 or the waveguide 207. However, the converter 80 can be provided so as to be directly coupled to the resonator 201 or to the resonator 205. Specifically, the blind via 87 of the converter 80 can be formed in the resonator 201 or the resonator 205 so as to extend inward from an opening in a part of the broad wall of the resonator 201 or a part of the broad wall of the resonator 205.

Thus, the configuration common to the BPF 1 and the BPF 2 has been described in detail with reference to (c) of FIG. 1, (c) of FIG. 2, FIG. 3, and FIG. 8.

<Configuration of BPF 1>

The following description will discuss a configuration unique to the BPF 1. As described above, (b) of FIG. 1 is an exploded perspective view illustrating the conductor layer 6a of the BPF 1. (a) of FIG. 5 is a plan view illustrating the conductor layer 6a. (a) of FIG. 1 is an exploded perspective view illustrating the resin layer 9a of the BPF 1. (a) of FIG. 4 is a plan view illustrating the resin layer 9a. FIG. 6 is a cross-sectional view of the BPF 1 taken along the line B-B′ in FIG. 3.

(Configuration of Cavities 301a Through 305a of BPF 1)

The resin layer 9a is disposed on the conductor layer 6a and inside openings (i.e., coupling windows AP₁₀₁ₐ through AP₁₀₅ₐ) (see (a) of FIG. 5)). A region of the conductor layer 6a and the openings (i.e., the coupling windows AP₁₀₁ₐ through AP₁₀₅ₐ) where the resin layer 9a is disposed is also referred to as a second region. In the present embodiment, polyimide is employed as a dielectric material constituting the resin layer 9a, but another resin can be employed. A conductor layer 8a (corresponding to “third conductor layer” in claims) is disposed on the resin layer 9a.

In a case where a polyimide thin film is employed as the resin layer 9a, a thickness of the polyimide thin film can be 16 μm.

(Pair of Broad Walls of BPF 1)

According to the configuration illustrated in FIG. 6, the conductor layers 6a and 8a constitute a pair of broad walls of each of cavities 301a through 305a in the BPF 1. As described above, the conductor layer 6a has five openings (i.e., coupling windows AP₁₀₁ₐ through AP₁₀₅ₐ) having respective radii R₆₁ₐ through R₆₅ₐ in the plan view (x-y plane) of the resonators 201 through 205, where each of the radii R₆₁ₐ through R₆₅ₐ is a radius from the center of each of the resonators 201 through 205. The five openings (i.e., the coupling windows AP₁₀₁ₐ through AP₁₀₅ₐ) are provided within a range of the above described second region.

(Shape of Cavities 301a Through 305a of BPF 1)

Each of the cavities 301a through 305a of the BPF 1 is formed by: two broad walls which face each other; and a narrow wall which resides between the two broad walls. The shape of each of the cavities 301a through 305a in the x-y plane is a circular shape. In another preferred embodiment, the shape can be a regular polygonal shape with six or more vertices, instead of the circular shape. In the case where the shape is a regular polygonal shape, the circumscribed circle of the regular polygonal shape corresponds to the above circular shape. The five cavities 301a through 305a are electromagnetically coupled to the corresponding five resonators 201 through 205, respectively, via the corresponding five coupling windows AP₁₀₁ₐ through AP₁₀₅ₐ. In a preferred embodiment, the centers of the resonators 201 through 205 coincide with respective centers of the cavities 301a through 305a in the plan view. In another preferred embodiment, it is only necessary that the center of at least one resonator (e.g., the resonator 203) coincides with the center of the corresponding cavity 303a in the plan view, and it is not necessary that the centers of all the lamination-type resonators coincide with respective centers of corresponding cavities.

In yet another preferred embodiment, it is possible to employ a configuration in which the centers of the resonators 201 through 205 are encompassed in the corresponding cavities 301a through 305a, respectively, in the plan view. It is only necessary that the center of at least one resonator (e.g., the resonator 203) is encompassed in the corresponding cavity (e.g., the cavity 303a) in the plan view, and it is not necessary that the centers of all the resonators are encompassed in the corresponding cavities, respectively, in the plan view.

(Extension Wall of BPF 1)

The shapes of inner extension walls 121a through 125a constituting the respective narrow walls of cavities 301a through 305a of the BPF 1 in the x-y plane are respective circular shapes having radii R₁₂₁ₐ through R₁₂₅ₐ, which are from the respective centers of the cavities 301a through 305a (see (a) of FIG. 1 and (a) of FIG. 4). In another preferred embodiment, the shape can be a regular polygonal shape with six or more vertices, instead of the circular shape. In the case where the shape is a regular polygonal shape, the circumscribed circle of the regular polygonal shape corresponds to the above circular shape. The inner extension walls 121a through 125a allow electrical communication between the two broad walls which are respectively constituted by the conductor layers 6a and 8a, and each of the inner extension walls 121a through 125a is combined with the two broad walls to form a columnar space that is electromagnetically closed except for the openings (i.e., the coupling windows AP₁₀₁ₐ through AP₁₀₅ₐ).

As illustrated in (a) of FIG. 1 and (a) of FIG. 4, the shapes of outer extension walls 111a through 115a which do not constitute the narrow walls of cavities 301a through 305a of the BPF 1 in the x-y plane are respective circular shapes having radii R₁₁₁ₐ through R₁₁₅ₐ, which are from the respective centers of the cavities 301a through 305a (see (a) of FIG. 4). In another preferred embodiment, the shape can be a regular polygonal shape with six or more vertices, instead of the circular shape. In the case where the shape is a regular polygonal shape, the circumscribed circle of the regular polygonal shape corresponds to the above circular shape. The outer extension walls 111a through 115a illustrated in (a) of FIG. 1 and (a) of FIG. 4 allow electrical communication between the two broad walls constituted by the respective conductor layers 6a and 8a (see FIG. 6).

(a) of FIG. 1 and (a) of FIG. 4 are schematic views which give priority to understandability of the shapes of the cavities 301a through 305a, and thicknesses of the inner extension walls 121a through 125a and the outer extension walls 111a through 115a in the radial direction are not represented. In FIG. 6, the thicknesses of the inner extension wall 123a and the outer extension wall 113a in the radial direction (which is the y-axis direction in FIG. 6) are represented. However, FIG. 6 is a schematic view which gives priority to understandability, and a scale ratio, an orientation, and the like of each constituent element are not necessarily accurate.

In the case where each of the inner extension walls 121a through 125a is constituted by a continuous conductor in the x-y plane, the inner extension walls 121a through 125a surround the respective resin layers 9a and constitute respective cavities 301a through 305a, as illustrated in (a) of FIG. 1 and FIG. 6. In another preferred embodiment, each of the inner extension walls 121a through 125a can be constituted by intermittent conductors in the x-y plane, provided that the inner extension walls 121a through 125a allow electrical communication between the two broad walls constituted by the respective conductor layers 6a and 8a. In the case where each of the inner extension walls 121a through 125a is constituted by intermittent conductors, cavities need to be electromagnetically formed.

As described above, the BPF 1 in accordance with the present embodiment is a five-pole resonator coupling type filter in which the five cavities 301a through 305a are disposed respectively on the corresponding five resonators 201 through 205 which are electromagnetically coupled to each other. The number of poles of the BPF 1 is not limited to five poles and, in another preferred embodiment, the BPF 1 can be configured to have any number of poles. Each of the cavities is filled with the resin layer 9a.

In the present embodiment, the cavities 301a through 305a are coupled to all the five resonators 201 through 205, respectively. However, the present embodiment is not limited to this configuration. That is, it is only necessary that the cavity is coupled to at least one resonator among the five resonators 201 through 205. For example, it is possible to employ a configuration in which the cavity 303a is coupled only to the resonator 203 of the third pole, and no cavities are coupled to the other resonators 201, 202, 204, and 205, which are of the first pole, the second pole, the fourth pole, and the fifth pole, respectively.

(Center-to-Center Distance Between Cavities of BPF 1)

(a) of FIG. 4 corresponds to a plan view of the BPF 1 taken along the broken line F-F′ of FIG. 6. As illustrated in (a) of FIG. 4, the radius of the cavity 301a is referred to as R₁₂₁ₐ, the radius of the cavity 302a is referred to as R₁₂₂ₐ, the radius of the cavity 303a is referred to as R₁₂₃ₐ (see FIG. 6), the radius of the cavity 304a is referred to as R₁₂₄ₐ, and the radius of the cavity 305a is referred to as R₁₂₅ₐ. In the present embodiment, centers C₃₁ₐ through C₃₅ₐ of the cavities 301a through 305a of the BPF 1 coincide with the centers C₁ through C₅ of the resonators 201 through 205, respectively, in the plan view. The center-to-center distance between the center C₃₁ₐ and the center C₃₂ₐ is referred to as E₁₂ₐ, the center-to-center distance between the center C₃₂ₐ and the center C₃₃ₐ is referred to as E₂₃ₐ, the center-to-center distance between the center C₃₃ₐ and the center C₃₄ₐ is referred to as E₃₄ₐ, and the center-to-center distance between the center C₃₄ₐ and the center C₃₅ₐ is referred to as E₄₅ₐ.

In the above arrangement, the radius R₁₂₁ₐ, the radius R₁₂₂ₐ, and the center-to-center distance E₁₂ₐ satisfy the condition E₁₂ₐ>R₁₂₁ₐ+R₁₂₂ₐ, the radius R₁₂₂ₐ, the radius R₁₂₃ₐ, and the center-to-center distance E₂₃ₐ satisfy the condition E₂₃ₐ>R₁₂₂ₐ+R₁₂₃ₐ, the radius R₁₂₃ₐ, the radius R₁₂₄ₐ, and the center-to-center distance E₃₄ₐ satisfy the condition E₃₄ₐ>R₁₂₃ₐ+R₁₂₄ₐ, and the radius R₁₂₄ₐ, the radius R₁₂₅ₐ, and the center-to-center distance E₄₅ₐ satisfy the condition E₄₅ₐ>R₁₂₄ₐ+R₁₂₅ₐ. Provided that such a condition is satisfied, two cylindrical cavities (for example, the cavity 301a and the cavity 302a) can be coupled only to corresponding resonators, respectively, via openings (for example, via the coupling windows AP₁₀₁ₐ and AP₁₀₂ₐ) without directly interfering with each other.

Moreover, the radii R₁₁₁ₐ through R₁₁₅ₐ of the respective outer extension walls 111a through 115a and the radii R₁ through R₅ of the respective resonators satisfy the conditions R₁₁₁ₐ≤R₁, R₁₁₂ₐ≤R₂, R₁₁₃ₐ≤R₃, R₁₁₄ₐ≤R₄, and R₁₁₅ₐ≤R₅, respectively.

(a) of FIG. 5 corresponds to a plan view of the BPF 1 taken along the broken line E-E′ of FIG. 6. As illustrated in (a) of FIG. 5, the radii of openings (i.e., the coupling windows AP₁₀₁ₐ through AP₁₁₅ₐ) in the second conductor layer 6a which correspond to the five resonators, respectively, are referred to as R₆₁ₐ through R₆₅ₐ. In the present embodiment, centers of the openings (i.e., the coupling windows AP₁₀₁ₐ through AP₁₁₅ₐ) in the second conductor layer 6a coincide with respective centers of the resonators 201 through 205 and the respective centers of the cavities 301a through 305a in the plan view.

In the above arrangement, the radii R₁₂₁ₐ through R₁₂₅ₐ of the respective inner extension walls 121a through 125a and the radii R₆₁ₐ through R₆₅ₐ of the respective openings (i.e., the coupling windows AP₁₀₁ₐ through AP₁₀₅ₐ) in the second conductor layer 6a satisfy the conditions R₁₂₁ₐ>R₆₁ₐ, R₁₂₂ₐ>R₆₂ₐ, R₁₂₃ₐ>R₆₃ₐ, R₁₂₄ₐ>R₆₄ₐ, and R₁₂₅ₐ>R₆₅ₐ, respectively. Provided that such conditions are satisfied, the second conductor layer 6a serves as one broad wall in the cavity (see FIG. 6).

In contrast, if the radii R₁₂₁ₐ through R₁₂₅ₐ of the respective inner extension walls 121a through 125a and the radii R₆₁ₐ through R₆₅ₐ of the respective openings (i.e., the coupling windows AP₁₀₁ₐ through AP₁₀₅ₐ) in the second conductor layer 6a satisfy the conditions R₁₂₁ₐ=R₆₁ₐ, R₁₂₂ₐ=R₆₂ₐ, R₁₂₃ₐ=R₆₃ₐ, R₁₂₄ₐ=R₆₄ₐ, and R₁₂₅ₐ=R₆₅ₐ, respectively, the second conductor layer 6a does not serve as a broad wall in the cavity.

In another embodiment, it is possible to employ a configuration in which the centers of the respective resonators 201 through 205 are encompassed in the corresponding coupling windows AP₁₀₁ₐ through AP₁₀₅ₐ, respectively, in the plan view. It is only necessary that the center of at least one resonator (e.g., the resonator 203) is encompassed in the corresponding coupling window (e.g., the coupling window AP₁₀₃ₐ) in the plan view, and it is not necessary that the centers of all the resonators 201 through 205 are encompassed in the corresponding openings (coupling windows), respectively, in the plan view.

<Configuration of BPF 2>

The following description will discuss a configuration unique to the BPF 2. As described above, (b) of FIG. 2 is an exploded perspective view illustrating the conductor layer 6b of the BPF 2. (b) of FIG. 5 is a plan view illustrating the conductor layer 6b. (a) of FIG. 2 is an exploded perspective view illustrating the resin layer 9b of the BPF 2. (b) of FIG. 4 is a plan view illustrating the resin layer 9b. FIG. 7 is a cross-sectional view of the BPF 2 taken along the line B-B′ in FIG. 3.

(Configuration of Cavities 301b Through 305b of BPF 2)

A resin layer 9b (corresponding to “second dielectric layer” in claims) is disposed on annular openings (i.e., coupling windows AP_{101b} through AP_{105b}) and on a part of the conductor layer 6b. A region in which the resin layer 9b is disposed on the annular openings (i.e., the coupling windows AP_{101b} through AP_{105b}) and on the part of the conductor layer 6b is also referred to as a second region. In the present embodiment, polyimide is employed as a dielectric material constituting the resin layer 9b, but another resin can be employed. A conductor layer 8b (corresponding to “third conductor layer” in claims) is disposed on the resin layer 9b.

In a case where a polyimide thin film is employed as the resin layer 9b, a thickness of the polyimide thin film can be 16 μm.

(Pair of Broad Walls of Cavities 301b Through 305b of BPF 2)

The conductor layers 6b and 8b constitute a pair of broad walls of each of the cavities 301b through 305b in the BPF 2. The cavities 301b through 305b can be configured to be smaller than the corresponding resonators 201 through 205, respectively, in the x-y plane. As described above, the conductor layer 6b has the five annular openings (i.e., the coupling windows AP_{101b} through AP_{105b}). The five annular openings (i.e., the coupling windows AP_{101b} through AP_{105b}) are provided within a range of the above described second region.

The conductor layer 8b constituting one of the broad walls has, by penetrating parts 141b through 145b, five annular shapes corresponding to the five cavities 301b through 305b, respectively, in the x-y plane.

(Shape of Cavities 301b Through 305b of BPF 2)

Each of the cavities 301b through 305b is formed by: two broad walls which face each other; and a narrow wall which resides between the two broad walls. The shapes of the cavities 301b through 305b in the x-y plane are respective annular shapes including circular penetrating parts 141b through 145b. That is, each of the cavities 301b through 305b has a tubular shape. Inner extension walls 131b through 135b constituting the respective penetrating parts 141b through 145b correspond to the “inner edges” of the “cavities” recited in claims. The cavities 301b through 305b are disposed so that the inner extension walls 131b through 135b include the respective centers of the resonators 201 through 205 in the plan view. In another preferred embodiment, the shape of the annular inner circle and/or outer circle can be a regular polygonal shape with six or more vertices, instead of the circular shape. In the case where the shape is a regular polygonal shape, the circumscribed circle of the regular polygonal shape corresponds to the above circular shape. The five cavities 301b through 305b are electromagnetically coupled to the corresponding five resonators 201 through 205, respectively, via the corresponding five coupling windows AP_{101b} through AP_{105b}. In a preferred embodiment, the centers of the resonators 201 through 205 coincide with respective centers of the cavities 301b through 305b in the plan view. In another preferred embodiment, it is only necessary that the center of at least one resonator (e.g., the resonator 203) coincides with the center of the corresponding cavity (e.g., the cavity 303b) in the plan view, and it is not necessary that the centers of all the resonators 201 through 205 coincide with respective centers of the corresponding cavities.

In yet another preferred embodiment, it is possible to employ a configuration in which the centers of the resonators 201 through 205 are encompassed in the corresponding cavities 301b through 305b, respectively, in the plan view. It is only necessary that the center of at least one resonator (e.g., the resonator 203) is encompassed in the corresponding cavity (e.g., the cavity 303b) in the plan view, and it is not necessary that the centers of all the resonators 201 through 205 are encompassed in the corresponding cavities, respectively, in the plan view.

(Extension Wall of BPF 2)

The shapes of outer extension walls 121b through 125b constituting the respective narrow walls of cavities 301b through 305b of the BPF 2 in the plan view are respective circular shapes having radii R_{121b} through R_{125b}, which are from the respective centers of the cavities 301b through 305b. Similarly, the shapes of the inner extension walls 131b through 135b constituting the respective narrow walls of cavities 301b through 305b of the BPF 2 in the x-y plane are respective circular shapes having radii R₁₃₁ through R₁₃₅. In another preferred embodiment, the shape of each of the outer extension walls 121b through 125b of the BPF 2 in the plan view can be a regular polygonal shape with six or more vertices, instead of the circular shape. In the case where the shape is a regular polygonal shape, the circumscribed circle of the regular polygonal shape corresponds to the above circular shape. The centers of the circles having the radii R₁₃₁ through R₁₃₅ preferably coincide with the respective centers of the cavities 301b through 305b of the BPF 2 in the plan view. However, the present embodiment is not limited to the aspect in which the centers coincide with the respective centers of the cavities 301b through 305b. In another preferred embodiment, the shape of each of the inner extension walls 131b through 135b of the BPF 2 in the plan view can be a regular polygonal shape with six or more vertices, instead of the circular shape. In the case where the shape is a regular polygonal shape, the circumscribed circle of the regular polygonal shape corresponds to the above circular shape.

The outer extension walls 121b through 125b and the inner extension walls 131b through 135b of the BPF 2 allow electrical communication between the two broad walls constituted by the respective conductor layers 6b and 8b. In the present embodiment, ends which are of the inner extension walls 131b through 135b constituting the respective penetrating parts 141b through 145b and are positioned on the negative z axis direction side are in electrical communication with the circular conductor layers 6b located at the respective center parts of upper faces of the resonators 201 through 205. Further, ends which are of the inner extension walls 131b through 135b constituting the respective penetrating parts 141b through 145b and are positioned on the positive z axis direction side are in electrical communication with respective annular conductor layers 8b. Moreover, the ends positioned on the negative z axis direction side of the outer extension walls 121b through 125b are in electrical communication with the conductor layer 6b located outside the annular openings (i.e., the coupling windows AP_{101b}through AP_{105b}) in the upper faces of the resonators 201 through 205. Further, ends positioned on the positive z axis direction side of the outer extension walls 121b through 125b are in electrical communication with the respective annular conductor layers 8b. With the arrangement, the narrow walls are combined with the pair of broad walls to form a hollow-cylindrical space that is electromagnetically closed except for the openings (i.e., the coupling windows AP_{101b} through AP_{105b}).

As illustrated in (b) of FIG. 4 and FIG. 7, the shapes of external extension walls 111b through 115b, which do not constitute the narrow walls of the cavities 301b through 305b of the BPF 2, in the x-y plane are circular shapes with radii R_{111b} through R_{115b}, respectively. The centers of the circles having the radii R_{111b} through R_{115b} preferably coincide with the respective centers of the cavities 301b through 305b in the plan view. However, the present embodiment is not limited to the aspect in which the centers coincide with the respective centers of the cavities 301b through 305b. In another preferred embodiment, the shape of each of the external extension walls 111b through 115b in the plan view can be a regular polygonal shape with six or more vertices, instead of the circular shape. In the case where the shape is a regular polygonal shape, the circumscribed circle of the regular polygonal shape corresponds to the above circular shape. The external extension walls 111b through 115b illustrated in (b) of FIG. 4 and FIG. 7 allow electrical communication between the two broad walls constituted by the respective conductor layers 6b and 8b.

(a) of FIG. 2 and (b) of FIG. 4 are schematic views which give priority to understandability of the shapes of the cavities 301b through 305b of the BPF 2, and thicknesses of the inner extension walls 131b through 135b, the outer extension walls 121b through 125b, and the external extension walls 111b through 115b in the radial direction are not represented. In FIG. 7, the thicknesses of the inner extension wall 133b, the outer extension wall 123b, and the external extension wall 113b in the radial direction (which is the y-axis direction in FIG. 7) are represented. However, FIG. 7 is a schematic view which gives priority to understandability, and a scale ratio, an orientation, and the like of each constituent element are not necessarily accurate.

In the case where each of the outer extension walls 121b through 125b of the BPF 2 is constituted by a continuous conductor in the x-y plane, the outer extension walls 121b through 125b surround the respective resin layers 9b and constitute the respective cavities 301b through 305b, as illustrated in (a) of FIG. 2 and FIG. 7. In another preferred embodiment, each of the outer extension walls 121b through 125b can be constituted by intermittent conductors in the x-y plane, provided that the outer extension walls 121b through 125b allow electrical communication between the two broad walls constituted by the respective conductor layers 6b and 8b. In the case where each of the outer extension walls 121b through 125b is constituted by intermittent conductors, cavities need to be electromagnetically formed.

In the case where each of the inner extension walls 131b through 135b of the BPF 2 is constituted by a continuous conductor in the x-y plane, the inner extension walls 131b through 135b constitute, on their inner sides, the respective penetrating parts 141b through 145b, as illustrated in (a) of FIG. 2 and FIG. 7. At the same time, the resin layer 9b is adjoined to the outside of the inner extension walls 131b through 135b to form the cavities 301b through 305b in pairs with the respective outer extension walls 121b through 125b. In another preferred embodiment, each of the inner extension walls 131b through 135b can be constituted by intermittent conductors in the x-y plane, provided that the inner extension walls 131b through 135b allow electrical communication between the two broad walls constituted by the respective conductor layers 6b and 8b. In the case where each of the inner extension walls 131b through 135b is constituted by intermittent conductors, cavities need to be electromagnetically formed between the outer extension walls 121b through 125b and the inner extension walls 131b through 135b, respectively.

As described above, the BPF 2 in accordance with the present embodiment is a five-pole resonator coupling type filter in which the five cavities 301b through 305b are disposed respectively on the corresponding five resonators 201 through 205 which are electromagnetically coupled to each other. The number of poles of the BPF 2 is not limited to five poles and, in another preferred embodiment, the BPF 2 can be configured to have any number of poles. The cavities are filled with the resin layers 9b between the outer extension walls 121b through 125b and the inner extension walls 131b through 135b, respectively.

In the present embodiment, the cavities 301b through 305b are coupled to all the five resonators 201 through 205, respectively. However, the present embodiment is not limited to this configuration. That is, it is only necessary that the cavity is coupled to at least one resonator among the five resonators 201 through 205. For example, it is possible to employ a configuration in which the cavity 303b is coupled only to the resonator 203 of the third pole, and no cavities are coupled to the other resonators 201, 202, 204, and 205 of the first pole, the second pole, the fourth pole, and the fifth pole, respectively.

(Center-to-Center Distance Between Cavities of BPF 2)

(b) of FIG. 4 corresponds to a plan view of the BPF 2 taken along the broken line F-F′ of FIG. 7. As illustrated in (b) of FIG. 4, in the BPF 2, the radius of the cavity 301b is referred to as R_{121b}, the radius of the cavity 302b is referred to as R_{122b}, the radius of the cavity 303b is referred to as R_{123b} (see FIG. 7), the radius of the cavity 304b is referred to as R_{124b}, and the radius of the cavity 305b is referred to as R_{125b}. In the present embodiment, centers of the cavities 301b through 305b of the BPF 2 coincide with the centers of the resonators 201 through 205, respectively, in the plan view. The centers of the cavities 301b through 305b are referred to as centers C_{31b} through C_{35b}, respectively, the center-to-center distance between the center C_{31b} and the center C_{32b} is referred to as E_{12b}, the center-to-center distance between the center C_{32b} and the center C_{33b} is referred to as E_{23b}, the center-to-center distance between the center C_{33b} and the center C_{34b} is referred to as E_{34b}, and the center-to-center distance between the center C_{34b} and the center C_{35b} is referred to as E_{45b}.

In the above arrangement, the radius R_{121b}, the radius R_{122b}, and the center-to-center distance E_{12b} satisfy the condition E_{12b}>R_{121b}+R_{122b}, the radius R_{122b}, the radius R_{123b}, and the center-to-center distance E_{23b} satisfy the condition E_{23b}>R_{122b}+R_{123b}, the radius R_{123b}, the radius R_{124b}, and the center-to-center distance E_{34b} satisfy the condition E_{34b}>R_{123b}+R_{124b}, and the radius R_{124b}, the radius R_{125b}, and the center-to-center distance E_{45b} satisfy the condition E_{45b}>R_{124b}+R_{125b}. Provided that such a condition is satisfied, two hollow-cylindrical cavities (for example, the cavity 301b and the cavity 302b of the BPF 2) can be coupled only to corresponding resonators, respectively, via openings (for example, via the coupling windows AP_{110b} and AP_{102b}) without directly interfering with each other.

Moreover, the radii R_{111b} through R_{115b} of the respective external extension walls 111b through 115b and the radii R₁ through R₅ of the respective resonators satisfy the conditions R_{111b}≤R₁, R_{112b}≤R₂, R_{113b}≤R₃, R_{114b}≤R₄, and R_{115b}≤R₅, respectively. Further, the external extension walls 111b through 115b and the outer extension walls 121b through 125b satisfy the conditions R_{111b}>R_{121b}, R_{112b}>R_{122b}, R_{113b}>R_{123b}, R_{114b}>R_{124b}, and R_{115b}>R_{125b}, respectively.

(b) of FIG. 5 corresponds to a plan view of the BPF 2 taken along the broken line E-E′ of FIG. 7. As illustrated in (b) of FIG. 5, the radii of openings (i.e., the coupling windows AP_{101b} through AP_{105b}) which are in the second conductor layer 6b and correspond to the five resonators, respectively, are referred to as R_{61b} through R_{65b}. In the present embodiment, centers of the openings (i.e., the coupling windows AP_{101b} through AP_{105b}) in the second conductor layer 6b coincide with respective centers of the resonators 201 through 205 and respective centers of the cavities 301b through 305b in the plan view.

In the above arrangement, the radii R_{121b} through R_{125b} of the respective outer extension walls 121b through 125b of the BPF 2 and the radii R_{61b} through R_{65b} of the respective openings (i.e., the coupling windows AP_{101b} through AP_{105b}) in the second conductor layer 6b satisfy the conditions R_{121b}>R_{61b}, R_{122b}>R_{62b}, R_{123b}>R_{63b}, R_{124b}>R_{64b}, and R_{125b}>R_{65b}. Provided that such conditions are satisfied, the second conductor layer 6b serves as one broad wall in the cavity (see FIG. 7).

In contrast, if the radii R_{121b} through R_{125b} of the respective outer extension walls 121b through 125b and the radii R_{61b} through R_{65b} of the respective openings (i.e., the coupling windows AP_{110b} through AP_{105b}) in the second conductor layer 6b satisfy the conditions R_{121b}=R_{61b}, R_{122b}=R_{62b}, R_{123b}=R_{63b}, R_{124b}=R_{64b}, and R_{125b}=R_{65b}, the second conductor layer 6b does not serve as a broad wall in the cavity.

In another embodiment, it is possible to employ a configuration in which the centers of the resonators 201 through 205 are encompassed in the corresponding penetrating parts 141b through 145b, respectively, in the plan view. It is only necessary that the center of at least one resonator (e.g., the resonator 203) is encompassed in the corresponding penetrating part (e.g., the penetrating part 143b) in the plan view, and it is not necessary that the centers of all the resonators 201 through 205 are encompassed in the corresponding penetrating parts, respectively, in the plan view.

[Change in Property in Accordance with Change in Temperature]

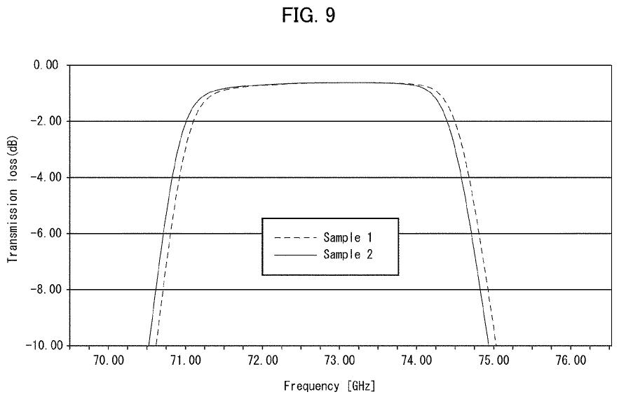

In the BPF 1 in accordance with Embodiment 1 (see FIG. 1) and the BPF 2 in accordance with Embodiment 2 (see FIG. 2), a temperature dependence of a dielectric constant of the substrate 5 may be problematic. For example, it is desirable to consider the temperature dependence of the dielectric constant of the substrate 5, particularly for use of a filter in an environment which is possibly accompanied by large change in temperature from a low temperature to a high temperature. The following description will discuss this point in detail with reference to FIG. 9.

<Temperature Dependence of Dielectric Constant>

In regard to a temperature dependence of a specific dielectric constant of quartz, it is known that the specific dielectric constant F of quartz increases in accordance with temperature rise from −40° C. to +100° C. In addition, in regard to a temperature dependence of a dielectric constant of a resin film, it is known that, for example, in a polyimide film or a polyamide imide film, the dielectric constant decreases in accordance with temperature rise from 20° C. to 100° C.

### COMPARATIVE EXAMPLE

FIG. 9 shows a simulation result of a transmission characteristic of a filter (hereinafter also referred to as “filter of Comparative Example”) in which the coupling windows AP₁₀₁ₐ through AP₁₀₅ₐ are not provided and the cavities 301a through 305a are omitted in the BPF 1 illustrated in FIG. 1. At a resonant frequency of a higher order mode, in view of electric field distribution in a cavity, influence of resonance is greater in a central portion than in a peripheral portion of the cavity. As simulation conditions, the radii R₁ and R₅ of the first and fifth resonators are 700 μm, the radii R₂ and R₄ of the second and fourth resonators are 725 μm, and the radius R₃ of the third resonator is 750 μm. A thickness of the quartz of the substrate 5 is 520 μm.

In the graph of FIG. 9, a sample 1 shows a simulation result of a case where the specific dielectric constant of quartz is 3.79 (i.e., corresponding to −40° C.) and a sample 2 shows a simulation result of a case where the specific dielectric constant of quartz is 3.8 (i.e., corresponding to +100° C.). As a result of the transmission characteristic simulation shown in FIG. 9, in the transmission characteristics of the sample 1 and the sample 2, shift of a center frequency can be confirmed. That is, in the BPF of Comparative Example, the center frequency of the passband is shifted to the low frequency side in accordance with the temperature rise of the use environment. In order to reduce such shift of the center frequency, a configuration of a cavity is considered as follows.

<Stacking of Cavity>

Next, temperature dependences of the BPF 1 (see FIG. 1) and the BPF 2 (see FIG. 1) in which the cavities 301a through 305a and 301b through 305b are stacked on the resonators via the coupling windows are analyzed.

As described above, in the case where the substrate 5 constituting the resonator is a dielectric layer made of quartz, the specific dielectric constant increases in accordance with temperature rise, and the center frequency is shifted to the low frequency side. In order to reduce the influence of such shifting, it is preferable to dispose a dielectric layer whose dielectric constant decreases in accordance with temperature rise inside the cavities 301a through 305a and 301b through 305b which are provided on the substrate 5 that is made of quartz. For example, a polyimide film has a dielectric constant which decreases in accordance with temperature rise. FIG. 1, FIG. 2, FIG. 6, and FIG. 7 are schematic views illustrating the resin layers 9a and 9b constituted by polyimide films arranged inside the cavities 301a through 305a and 301b through 305b. By employing such a multilayered structure, it is possible to reduce the influence of the shift of the center frequency in accordance with temperature rise.

By adjusting a volume ratio between the substrate 5 and the resin layer 9a or 9b in accordance with a contribution ratio of temperature dependence of dielectric constant, it is possible to reduce the influence of the shift of the center frequency.

In a case where the temperature dependence of the dielectric constant of the resin layers 9a and 9b (corresponding to “second dielectric layer” in claims) is greater than the temperature dependence of the dielectric constant of the substrate 5 (corresponding to “first dielectric layer” in claims), the volume of the substrate 5 is preferably greater than the volume of the resin layers 9a and 9b.

In the above example, the substrate 5 is constituted by a dielectric material whose dielectric constant increases in accordance with temperature rise. In contrast, in a case where the substrate 5 is constituted by a dielectric material whose dielectric constant decreases in accordance with temperature rise, each of the resin layers 9a and 9b is preferably constituted by a dielectric material whose dielectric constant increases in accordance with temperature rise. It is preferable to combine dielectric materials in a relation in which tendencies of change in dielectric constant with respect to change in temperature are cancelled in a temperature range where a particular change in temperature occurs.

In yet another embodiment, it is preferable to combine dielectric materials in a relation in which tendencies of change in dielectric constant with respect to change in temperature are reduced in a temperature range where a particular change in temperature occurs. That is, the tendencies of change in dielectric constant may not be necessarily cancelled, and it may be enough to reduce the temperature dependence of the dielectric constant, depending on the use environment. Therefore, it is preferable to use, in combination with the substrate 5, each of the resin layers 9a and 9b (corresponding to “second dielectric layer” in claims) having the temperature dependence of the dielectric constant which is opposite to the temperature dependence of the dielectric constant of the substrate 5 (corresponding to “first dielectric layer” in claims).

It is known that a polyamide imide film has a dielectric constant which decreases in accordance with temperature rise in a rage from 20° C. to 100° C. but increases in accordance with temperature rise in a range from 100° C. to 240° C. Therefore, in a case where the change in temperature of the environment in which the bandpass filter is used is in the range from 100° C. to 240° C. and a polyamide imide film is used as the resin layer 9a or 9b, it is preferable to use, as the substrate 5, a dielectric material whose dielectric constant decreases in the same range of change in temperature.

(Substrate 5 Including Dielectric Layer in which Temperature Dependence of Dielectric Constant is Inverted)

In a case where the temperature of the environment in which the filter is used widely changes, the temperature dependence of the dielectric constant may change in accordance with the temperature range. For example, in a case where the temperature of the environment in which the filter is used changes from about 20° C. to about 160° C., it should be noted that the temperature dependence of the dielectric constant greatly changes when the resin layers 9a and 9b are constituted by polyamide imide films. The dielectric constant of the polyamide imide film decreases in accordance with temperature rise in a rage from 20° C. to 100° C. but increases in accordance with temperature rise in a range of 100° C. or higher. Assuming the use of the filter in such change in temperature, it is preferable to use, as the substrate 5, a dielectric material whose dielectric constant increases in accordance with temperature rise in the range from 20° C. to 100° C. and decreases in accordance with temperature rise in the range of 100° C. or higher. Even in such a case, it is possible to reduce shift of the center frequency by combining dielectric materials in a relation in which tendencies of change in dielectric constant with respect to change in temperature are cancelled or reduced in a temperature range where a particular change in temperature occurs.

Aspects of the present invention can also be expressed as follows:

A filter in accordance with an aspect 1 of the present invention includes: a post-wall waveguide which includes a substrate that is provided with a first conductor layer on one main surface, a second conductor layer on the other main surface, and post walls disposed inside the substrate, the post-wall waveguide functioning as a plurality of resonators which are electromagnetically coupled to each other; and cavities which are disposed on the post-wall waveguide, the cavities being electromagnetically coupled to the respective plurality of resonators via coupling windows that are provided in the second conductor layer, the substrate including a first dielectric layer which is constituted by a first dielectric material, each of the cavities including therein a second dielectric layer which is constituted by a second dielectric material, a dielectric constant of the first dielectric material increasing in accordance with temperature rise and a dielectric constant of the second dielectric material decreasing in accordance with temperature rise which is in the same range as said temperature rise, or the dielectric constant of the first dielectric material decreasing in accordance with temperature rise and the dielectric constant of the second dielectric material increasing in accordance with temperature rise which is in the same range as said temperature rise.

According to the configuration, it is possible to cancel or reduce temperature dependences by combining a plurality of dielectric materials having opposite temperature dependences of dielectric constant, and this makes it possible to reduce shift of a center frequency of a passband (hereinafter, also simply referred to as “center frequency”) which is caused in accordance with change in temperature.

In the filter in accordance with an aspect 2 of the present invention, it is possible, in the aspect 1, that: the cavities are encompassed in the respective plurality of resonators in a plan view of the post-wall waveguide; each of the cavities includes a third conductor layer which is disposed on the second dielectric layer and an extension wall via which a short circuit is achieved between the third conductor layer and the second conductor layer; the second dielectric layer is provided inside each of the cavities and also inside each of the coupling windows and is disposed on each of the plurality of resonators so as to be in contact with the first dielectric layer; the third conductor layer serves as one broad wall of each of the cavities; the extension wall serves as a narrow wall of each of the cavities; and the coupling windows are encompassed in the respective plurality of resonators in the plan view of the post-wall waveguide.

According to the configuration, the resonators can be electromagnetically coupled to the corresponding cavities, respectively, with high coupling efficiency. This makes it possible to surely bring about the effect of reducing shift of the center frequency.

In the filter in accordance with an aspect 3 of the present invention, it is possible, in the aspect 1 or 2, that the coupling windows are disposed so as to encompass respective centers of the plurality of resonators in the plan view of the post-wall waveguide.

According to the configuration, the resonators can be electromagnetically coupled to the corresponding cavities, respectively, with high coupling efficiency. This makes it possible to surely bring about the effect of reducing shift of the center frequency.

In the filter in accordance with an aspect 4 of the present invention, it is possible, in any of the aspects 1 through 3, that: each of the cavities has a tubular shape; each of the coupling windows has an annular shape in the plan view of the post-wall waveguide; and the coupling windows are provided in respective ranges of the cavities in the plan view of the post-wall waveguide.

According to the configuration, it is possible to provide the filter that is capable of adjusting the center frequency by adjusting inner diameters of the cavities.

In the filter in accordance with an aspect 5 of the present invention, it is possible, in the aspect 4, that the cavities are disposed so that inner edges of the respective cavities encompass the respective centers of the plurality of resonators in the plan view of the post-wall waveguide.

According to the configuration, it is possible to control the center frequency more effectively.

In the filter in accordance with an aspect 6 of the present invention, it is possible, in any of the aspects 1 through 5, that a temperature dependence of the dielectric constant of the second dielectric material is greater than that of the dielectric constant of the first dielectric material, and a volume of the first dielectric material is greater than that of the second dielectric material.

According to the configuration, it is possible to reduce, by considering a contribution ratio of the change in temperature, shift of the center frequency which is caused in accordance with change in temperature, by considering the volume of the dielectric material layer in accordance with the magnitude of temperature dependence of each of the dielectric materials.

In the filter in accordance with an aspect 7 of the present invention, it is possible, in any of the aspects 1 through 6, that: each of the plurality of resonators has a circular shape or a regular polygonal shape with six or more vertices in the plan view of the post-wall waveguide; and any two resonators which are coupled to each other among the plurality of resonators are disposed so as to satisfy D<R₁+R₂, where R₁ and R₂ represent respective radii of circumscribed circles of the two resonators, and D represents a center-to-center distance between the two resonators.

According to the configuration, in a case where focus is given to two first cavities which are coupled to each other among the plurality of first cavities, the shape of a combination of two circumscribed circles of the two first cavities is symmetric with respect to a line that connects the centers of the two circumscribed circles together. This makes it possible to reduce the number of design parameters of the filter.

In the filter in accordance with an aspect 8 of the present invention, it is possible, in any of the aspects 1 through 7, that: a contour of each of the cavities is a circular shape or a regular polygonal shape with six or more vertices in the plan view of the post-wall waveguide; the centers of the cavities coincide with the respective centers of the plurality of resonators in the plan view of the post-wall waveguide; and any two cavities which are provided for respective two resonators that are coupled to each other among the plurality of resonators are disposed so as to satisfy E>R₃+R₄, where R₃ and R₄ represent respective radii of circumscribed circles of the two cavities, and E represents a center-to-center distance between the two cavities.

According to the configuration, it is possible to provide the filter in which adjacent two cavities do not overlap each other and the cavities are electromagnetically coupled only to the corresponding resonators, respectively.

In the filter in accordance with an aspect 9 of the present invention, it is possible, in any of the aspects 1 through 8, that the first dielectric material contains, as a main component, a material selected from the group consisting of quartz, sapphire, and alumina.

According to the configuration, it is possible to sufficiently reduce shift of the center frequency caused in accordance with change in temperature by constituting the substrate with a suitable dielectric material.

In the filter in accordance with an aspect 10 of the present invention, it is possible, in any of the aspects 1 through 9, that the second dielectric material contains, as a main component, a material selected from polyimide or polyamide imide.

According to the configuration, it is possible to sufficiently reduce shift of the center frequency caused in accordance with change in temperature by constituting the resin layer with a suitable dielectric material.

[Additional Remarks]

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1, 2: Bandpass filter (filter)
5: Substrate (first dielectric layer)
6a, 6b: Conductor layer (second conductor layer)
7: Conductor layer (first conductor layer)
8a, 8b: Conductor layer (third conductor layer)
9a, 9b: Resin layer (second dielectric layer)
21 through 25, 61, 62, 71, 72: Post wall
21i through 25i, 61i through 64i, 71i through 73i: Conductor post
63, 64, 73: Short wall
80: Converter
81: Dielectric layer
85: Signal line
86: Pad
87: Blind via
88, 89: Electrode
88A, 89A: Via
111a through 115a, 121b through 125b: Outer extension wall
111b through 115b: External extension wall
121a through 125a, 131b through 135b: Inner extension wall
141b through 145b: Penetrating part
201 through 205: Resonator
206, 207: Waveguide
301a through 305a, 301b through 305b: Cavity
6c, 81a, AP₁₂, AP₂₃, AP₃₄, AP₄₅, AP₁, AP_{O}: Opening
AP₁₀₁ₐ through AP₁₀₅ₐ, AP_{101b} through AP_{105b}: Coupling window

1. A filter, comprising:
a post-wall waveguide which includes a substrate that is provided with a first conductor layer on one main surface, a second conductor layer on the other main surface, and post walls disposed inside the substrate, the post-wall waveguide functioning as a plurality of resonators which are electromagnetically coupled to each other; and
cavities which are disposed on the post-wall waveguide, the cavities being electromagnetically coupled to the respective plurality of resonators via coupling windows that are provided in the second conductor layer,
the substrate including a first dielectric layer which is constituted by a first dielectric material,
each of the cavities including therein a second dielectric layer which is constituted by a second dielectric material,
a dielectric constant of the first dielectric material increasing in accordance with temperature rise and a dielectric constant of the second dielectric material decreasing in accordance with temperature rise which is in the same range as said temperature rise, or
the dielectric constant of the first dielectric material decreasing in accordance with temperature rise and the dielectric constant of the second dielectric material increasing in accordance with temperature rise which is in the same range as said temperature rise.

2. The filter as set forth in claim 1, wherein:
the cavities are encompassed in the respective plurality of resonators in a plan view of the post-wall waveguide;
each of the cavities includes a third conductor layer which is disposed on the second dielectric layer and an extension wall via which a short circuit is achieved between the third conductor layer and the second conductor layer;
the second dielectric layer is provided inside each of the cavities and also inside each of the coupling windows and is disposed on each of the plurality of resonators so as to be in contact with the first dielectric layer;
the third conductor layer serves as one broad wall of each of the cavities;
the extension wall serves as a narrow wall of each of the cavities; and
the coupling windows are encompassed in the respective plurality of resonators in the plan view of the post-wall waveguide.

3. The filter as set forth in claim 1, wherein the coupling windows are disposed so as to encompass respective centers of the plurality of resonators in the plan view of the post-wall waveguide.

4. The filter as set forth in claim 1, wherein:
each of the cavities has a tubular shape;
each of the coupling windows has an annular shape in the plan view of the post-wall waveguide; and
the coupling windows are provided in respective ranges of the cavities in the plan view of the post-wall waveguide.

5. The filter as set forth in claim 4, wherein the cavities are disposed so that inner edges of the respective cavities encompass the respective centers of the plurality of resonators in the plan view of the post-wall waveguide.

6. The filter as set forth in claim 1, wherein a temperature dependence of the dielectric constant of the second dielectric material is greater than that of the dielectric constant of the first dielectric material, and a volume of the first dielectric material is greater than that of the second dielectric material.

7. The filter as set forth in claim 1, wherein:
each of the plurality of resonators has a circular shape or a regular polygonal shape with six or more vertices in the plan view of the post-wall waveguide; and
any two resonators which are coupled to each other among the plurality of resonators are disposed so as to satisfy D<R₁+R₂, where R₁ and R₂ represent respective radii of circumscribed circles of the two resonators, and D represents a center-to-center distance between the two resonators.

8. The filter as set forth in claim 1, wherein:
a contour of each of the cavities is a circular shape or a regular polygonal shape with six or more vertices in the plan view of the post-wall waveguide;
the centers of the cavities coincide with the respective centers of the plurality of resonators in the plan view of the post-wall waveguide; and
any two cavities which are provided for respective two resonators that are coupled to each other among the plurality of resonators are disposed so as to satisfy E>R₃+R₄, where R₃ and R₄ represent respective radii of circumscribed circles of the two cavities, and E represents a center-to-center distance between the two cavities.

9. The filter as set forth in claim 1, wherein the first dielectric material contains, as a main component, a material selected from the group consisting of quartz, sapphire, and alumina.

10. The filter as set forth in claim 1, wherein the second dielectric material contains, as a main component, a material selected from polyimide or polyamide imide.
